(19) United States
(12) Patent Application Publication
(10) Pub. No.: US 2007/0274591 A1
(43) Pub. Date: Nov. 29, 2007

(54) INPUT APPARATUS AND INPUT METHOD THEREOF

(75) Inventor: CHING-TZUN CHANG, TAIPEI CITY 116 (TW)

Correspondence Address: ROSENBERG, KLEIN & LEE, 3458 ELLICOTT CENTER DRIVE-SUITE 101, ELLICOTT CITY, MD, 21043, US

(73) Assignee: ELITEGROUP COMPUTER SYSTEMS CO., LTD., TAIPEI CITY 114 (TW)

(21) Appl. No.: 11/753,897

(22) Filed: May 25, 2007

(30) Foreign Application Priority Data
May 26, 2006 (TW) 095118917

(51) Int. Cl. G06K 9/00; G06F 3/041

(52) U.S. Cl. 382/187; 345/173

(57) ABSTRACT

An input apparatus and input method thereof are disclosed. The input apparatus includes an input interface, a processing unit and an execution unit. The input interface is a touch screen or a touch panel that is provided for a user to input a handwritten track with a stroke by utilizing a finger or a stylus. The processing unit then analyzes and compares with the turning trend of the handwritten track with a predetermined handwritten track. Lastly, the execution unit executes a predetermined corresponding function based on the degree of the similarity between the two turning trends.

### FIELD OF THE INVENTION

The present invention relates to an input apparatus and input method thereof, and more particularly to a technical field that analyzes and compares with a turning trend of a handwritten track.

### BACKGROUND OF THE INVENTION

FIG. 1 is a schematic diagram illustrating a conventional way to control an electronic apparatus. As shown, a user 10 usually uses his/her head, face, eyes or hands to operate the electronic apparatus 11 through a camera 12 disposed thereon for capturing body images of the user 10. The variation between captured images is utilized to determine which predetermined functions should be performed. For example, the shakes of the head of the user are utilized to adjust display angles of the electronic apparatus 11. Alternatively the movement of hands or the change of gestures is utilized to drive the electronic apparatus 11 to start or shut down some multimedia functions. Alternatively the rotation of eyeballs of the user 10 is utilized to control the control cursor on the display of the electronic apparatus 11.

FIG. 2 is a schematic diagram illustrating another way to control an electronic apparatus. As shown, the user 10 uses a microphone or other speech input apparatuses 20 to control the electronic apparatus 11. The electronic apparatus 11 captures a speech signal of the user 10 through the microphone or the speech apparatus 20, and some scripts captured from a script database are shown on the screen thereof, or some speech commands are determined by recognizing the speech signal to perform some predetermined functions. For example, when the user 10 says “the present invention is to illustrate”, the electronic apparatus 11 then displays “the present invention is to illustrate”. Alternatively, when the user 10 says “please shutdown”, the electronic apparatus 11 then performs a shutdown procedure.

FIG. 3 is a schematic diagram illustrating another way to control an electronic apparatus. As shown, the user 10 uses a touch screen 30 or a touch panel 31 to control the electronic apparatus 11. The user 10 uses a stylus 32 to perform handwritten script input, script matching, script determination, approximate script selection and selected script display on the touch screen 30 or the touch panel 31. Alternatively the stylus 32 is utilized to directly touch function checks displayed on the touch screen 30.

However, the aforementioned conventional techniques must have higher recognition rates, and the camera, the microphone or the speech input apparatus or the touch panel is inconvenience for the electronic apparatus in portability. In addition, when the user is operating a portable electronic apparatus during walking, it is not easy for the user to use the stylus to touch small scripts or a function table shown on a display screen of the portable electronic apparatus. Alternatively, when the user receives in a meeting a private important short message through his/her electronic apparatus, the user seems unable to use body images, audio recognitions or the stylus for selecting a small phonetic transcription check, and the user cannot use the handwritten recognitions, which is not friendly to the user on the wrong word selection, to manipulate the response of the electronic apparatus. Alternatively, when the user needs to use engineering calculator software, the user must use the stylus, a mouse or other peripheral input equipments to select one by one from Start/Programs/ . . . shown on the display screen to find the software. The approach is also inconvenient to the user. Moreover, the user would like to use a portable electronic apparatus during driving. For example, when a personal digital assistant (PDA) is utilized to connect a car stereo for listening music and when the user needs to turn the volume generated from the PDA, it is also inconvenient to the user that the user needs to select a small volume graphic shown on a screen of the PDA through the stylus so as to control the volume.

To overcome the foregoing issues, the inventor of the present invention based on years of experience on related research and development invents an input apparatus and input method thereof to overcome the foregoing shortcoming.

### SUMMARY OF THE INVENTION

In view of the foregoing issues, a first objective of the present invention is to provide an input apparatus for a user to use a handwritten track with a stroke to perform an indicated predetermined function.

A second objective of the present invention is to provide an input apparatus and input method with simple implementation and high recognition rate. A third objective of the present invention is to provide an input apparatus and input method that are suitable for an operation interface of a portable electronic apparatus and that is user-friendly.

In order to achieve the above objects, the input apparatus comprises an input interface, a processing unit and an execution unit. The input interface is preferably a touch screen or a touch panel, and is provided for the user to input a handwritten track with a stroke by using a finger or a stylus. The input interface at predetermined timing intervals records a coordinate point of the handwritten track to generate a series of coordinate points. The processing unit then analyzes a turning trend of the handwritten track, or compares a turning trend of the handwritten track with a predetermined turning trend, thereby computing angles or vector slopes and lengths between adjacent coordinate points. A series of coordinate points of the turning trend is further calculated based on the variety of the vector slopes or the angles between the adjacent coordinate points. In another word, the number and angle or vector slope of the coordinate point is calculated. The execution unit then executes a predetermined corresponding function based on the degree of the similarity between two turning trends or the comparison result of the turning trend. It should be noted that the predetermined corresponding function is preferably an automatic transmission back for predetermined messages, an engineering calculator, a volume adjusting or a quick shortcut equivalent to hardware buttons. The predetermined corresponding function is executed by the handwritten track with a heart-shaped or a-shaped or a clockwise circling or a counter-clockwise circling. Moreover, the user can also execute the quick shortcut equivalent to hardware buttons by using any one predetermined handwritten path with a stroke. The quick shortcut equivalent to hardware buttons is preferably an execution program, a cut function, a paste function, a specific sentence or a macro function.

The present invention also discloses an input method comprising the following steps:

(a) Inputting a handwritten track with a stroke through a touch screen or a touch panel;

(b) Comparing the turning trend of the handwritten track with a predetermined turning trend; and

(c) Executing a predetermined corresponding function based on the degree of similarity between two turning trends or the comparison result of the turning trend.

A coordinate point of the handwritten track at predetermined timing intervals is recorded to generate a series of coordinate points. Angles and lengths between adjacent coordinate points are calculated based on the coordinate points. A series of coordinate points of the turning trend is then calculated through the variety of the angles. Finally, the angles and the number of the turning trend are compared with a predetermined database in order to verify the corresponding function. It should be noted that the predetermined corresponding function is preferably an automatic transmission back for predetermined messages, an engineering calculator, a volume adjusting or a quick shortcut equivalent to hardware buttons. The predetermined corresponding function is executed by the handwritten track with a heart-shaped or a-shaped or a clockwise circling or a counter-clockwise circling. Moreover, the quick shortcut equivalent to hardware buttons is implemented by using any one predetermined handwritten path with a stroke. The quick shortcut equivalent to hardware buttons is preferably an execution program, a cut function, a paste function, a specific sentence or a macro function.

The invention can be more fully understood by reading following detailed description of the preferred embodiment with reference made to the accompanying drawings.

### BRIEF DESCRIPTION OF THE DRAWINGS

FIG. 1 is a schematic diagram of operating an electronic apparatus in prior arts;

FIG. 2 is another schematic diagram of operating an electronic apparatus in prior arts;

FIG. 3 is a further schematic diagram of operating an electronic apparatus in prior arts;

FIG. 4 is a schematic diagram of an input apparatus according to an embodiment of the present invention;

FIG. 5 is a schematic diagram of an input interface according to an embodiment of the present invention;

FIG. 6 is a schematic diagram of an input interface according to an embodiment of the present invention;

FIG. 7 is a schematic diagram of an input interface according to an embodiment of the present invention;

FIG. 8 is a schematic diagram of an input interface according to an embodiment of the present invention; and

FIG. 9 is a flowchart of an input method according to an embodiment of the present invention.

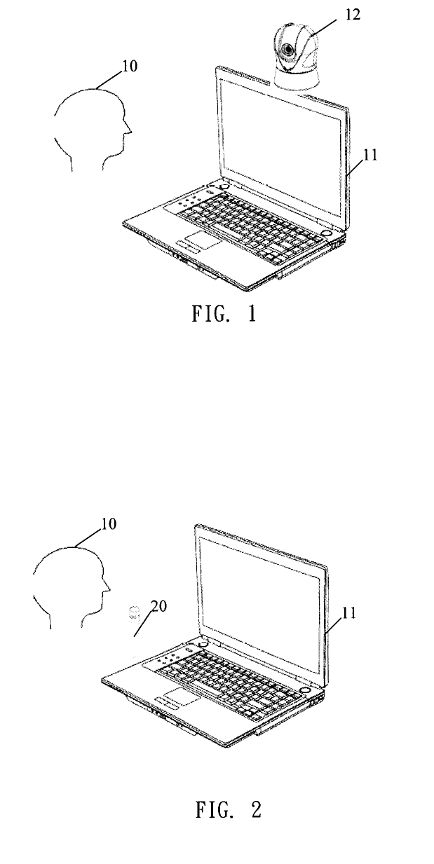

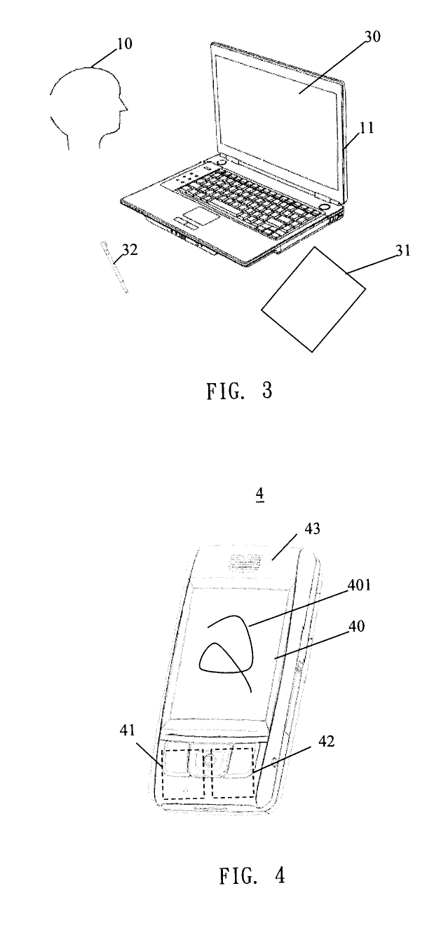

### DETAILED DESCRIPTION OF THE PREFERRED EMBODIMENTS

Refer to the related figures for an input apparatus according to a preferred embodiment of the present invention, wherein the same elements are described by the same reference numerals.

FIG. 4 is a schematic diagram for illustrating an embodiment of an input apparatus according to the present invention. As shown, the input apparatus 4 includes an input interface 40, a processing unit 41 and an execution unit 42. The input interface 40 is preferably a touch panel or a touch screen, and is disposed on a portable device, such as a portable computer or a personal digital assistant (PDA) 43. A user can use a finger or a stylus to input a handwritten track 401 with a stroke, wherein the handwritten track 401 has a turning trend. The processing unit 41 is preferably software or a hardware circuit for analyzes the turning trend of the handwritten track 401. Alternatively, the processing unit 41 compares the turning trend of the handwritten track 401 with that of the turning trend of another handwritten track previously stored in a database. In addition, the execution unit is preferably software or a hardware circuit. If the degree of the similarity of the turning trend between the two handwritten tracks is high, then the execution unit executes a predetermined corresponding function based on the turning trends.

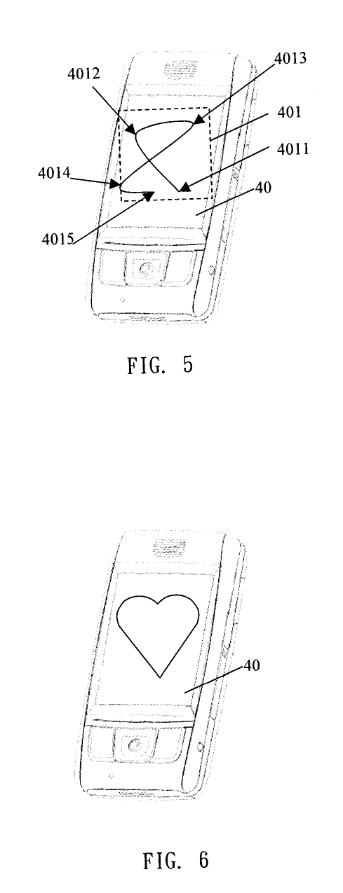

Now referring to FIG. 4 and FIG. 5, FIG. 5 is a schematic diagram for illustrating an embodiment of an input interface according to the present invention. As shown, while the user is firstly inputting the handwritten track, the input interface 40 records at predetermined timing intervals, such as 10 millisecond (ms), the value of a coordinate point on the handwritten track 401 so that values of a series of the coordinate points 4011, 4012, 4013, 4014 and 4015 will be generated accordingly. The processing unit 41 then calculates angles or vector slopes and lengths between these coordinate points 4011, 4012, 4013, 4014 and 4015 and adjacent coordinate points 4011, 4012, 4013, 4014 and 4015, such as the angle or the vector slope and the length from the coordinate point 4011 to 4012. Afterward, the processing unit calculates the number and angle or vector slope of the coordinate point of the turning trend by continuously using the variety of the angles or the vector slopes. It should be noted that the processing unit 41 also saves a predetermined handwritten track taken from the aforementioned calculated result so as to be provided for comparing with a second handwritten track.

FIG. 6 is a schematic diagram for illustrating an embodiment of an input interface according to the present invention. When a user uses his/her fingers or a stylus to draw in a meeting a heart shape on the touch screen of the input interface 40, the input apparatus compares the heart shape with another heart shape previously stored in the database. If there is high similarity between two heart shapes, the input apparatus then automatically transmits a predetermined message to a predetermined receiving end such as “Don't wait for me, you could take a dish first.”

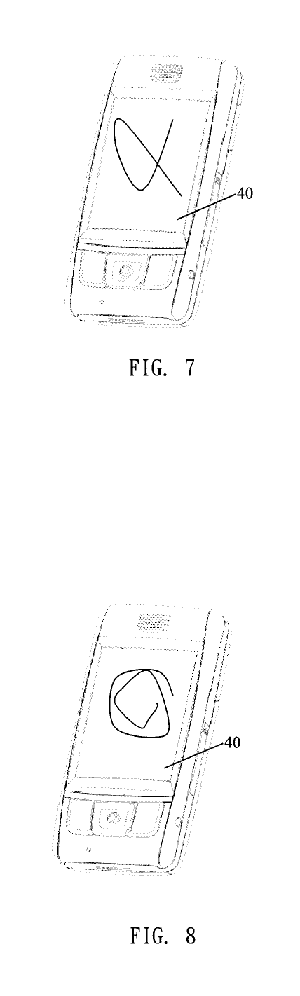

FIG. 7 is a schematic diagram for illustrating an embodiment of an input interface according to the present invention. When the user would like to use an engineering calculator, the user can use his/her finger or the stylus to draw a “α” on the touch screen of the input interface 40, and then the input apparatus will automatically activate the engineering calculator.

FIG. 8 shows a schematic diagram for illustrating an embodiment of an input interface according to the present invention. If the user would like to adjust the volume of the portable computer or the PDA, the user only needs to draw a circle clockwise on the touch screen of the input interface 40 for increasing the volume or to draw a circle anticlockwise for turning it down.

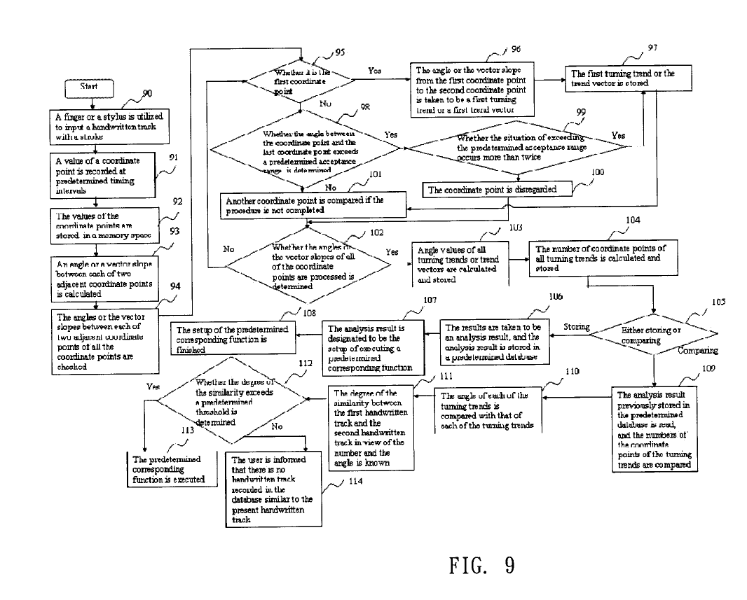

FIG. 9 is a flow chart showing the steps for a preferred embodiment of the input method according to the present invention. As shown, the input method includes the following steps.

In step 90, a finger or a stylus is utilized to input a handwritten track with a stroke on an input interface, such as c-shaped, clockwise or counterclockwise circling or any predetermined handwritten track with a stroke.

In step 91, while a user is inputting the handwritten track, a value of a coordinate point on the handwritten track is recorded at predetermined timing intervals, such as 10 ms, in order to generate values of a series of coordinate points.

In step 92, the values of the coordinate points obtained from step 91 are stored in a memory space.

In step 93, an angle or a vector slope between each of two adjacent coordinate points of all the coordinate points on the handwritten track is calculated.

In step 94, the angles or the vector slopes between each of two adjacent coordinate points of all the coordinate points are checked from the first coordinate point (the initial coordinate point on the handwritten track) sequentially.

In step 95, whether the coordinate point is the first coordinate point is determined. If the coordinate point is the first coordinate point, then the procedure goes to step 96; otherwise the procedure goes to step 98.

In step 96, the angle or the vector slope from the first coordinate point to the second coordinate point (the subsequent coordinate point to the first coordinate point on the handwritten track) is taken to be a first turning trend or a first trend vector.

In step 97, the first turning trend or the trend vector obtained from step 96 is stored and goes to step 101.

In step 98, whether the angle between the coordinate point and the last coordinate point is the same or exceeds a predetermined acceptance range, such as twenty degrees, is determined. If the angle exceeds the predetermined acceptance range, then the procedure goes to step 99; otherwise the procedure goes to step 101.

In step 99, whether the angle between the two adjacent coordinate points exceeds the turning trend or the trend vector obtained from step 97 plus the predetermined acceptance range is determined; that is to say, this step is to determine whether the situation of exceeding the predetermined acceptance range illustrated in step 98 occurs more than twice. If yes, another new turning trend or another new trend vector is generated and goes to step 97 in order to store the new turning trend or the new trend vector.

In step 100, the determination on misjudging turning angles can be avoided by disregarding the coordinate point.

In step 101, based on step 102, another coordinate point is compared if the procedure is not completed.

In step 102, based on the values of all coordinate points obtained from step 92, whether the angles or the vector slopes of all of the coordinate points are processed for generating the new turning trend or the new trend vector to be saved is determined. If all of the coordinate points are processed, then the procedure goes to step 103; otherwise the procedure goes to step 95.

In step 103, angle values of all turning trends or trend vectors are calculated and stored according to step 97.

In step 104, the number of coordinate points of all turning trends is calculated and stored according to step 97.

In step 105, either storing or comparing the aforesaid angles or vector slopes and the number (analysis result) is determined. For storing, the procedure goes to step 106, step 107 and step 108; otherwise the procedure goes to step 109 for comparing. It should be noted that when the user inputs a first handwritten track onto the touch screen of the input interface 40, step 92, 97, 103 and 104 will respectively generate the values of the coordinate points, the turning trend or the trend vector, the angle of each of the turning trend or the trend vector, and the numbers of a series of the coordinate points of each of the turning trend or the trend vector based on the first handwritten track. Furthermore, several handwritten tracks can be inputted onto the screen by the user's fingers or a stylus. For instance, when a second handwritten track is inputted, step 92, 97, 103 and 104 will respectively generate the corresponding results based on the second handwritten track. The results generated from both the first handwritten track and the second handwritten track can be respectively stored in step 106. Alternatively, the result from the second handwritten track can replace that from the first handwritten track. Alternatively, the result from the second handwritten track is compared with that from the first handwritten track in step 109.

In step 106, the results obtained from step 92, 97, 103 and 104 are taken to be an analysis result, and the analysis result is stored in a predetermined database.

In step 107, the analysis result is designated to be the setup of executing a predetermined corresponding function, such as returning a predetermined message, activating an engineering calculator, adjusting the volume or equaling a fast shortcut of the button of the hardware.

In step 108, the setup of the predetermined corresponding function is finished.

In step 109, the analysis result previously stored in the predetermined database is read, and the numbers of the coordinate points of the turning trends are compared. In another word, in the analysis result generated from the first handwritten track, the number of a series of the coordinate points of each turning trend is compared with that of the number of a series of the coordinate points of each of the turning trend in the second handwritten track.

In step 110, in the analysis result of the first handwritten track, the angle of each of the turning trends is compared with that of each of the turning trends in the second handwritten track.

In step 111, the degree of the similarity between the first handwritten track and the second handwritten track in view of the number and the angle compared in step 109 and 110 is known.

In step 112, whether the degree of the similarity exceeds a predetermined threshold is determined. If the similarity exceeds the predetermined threshold (qualification), then the procedure goes to step 113, otherwise (disqualification) the procedure goes to step 114.

In step 113, the predetermined corresponding function set in step 107 is executed.

In step 114, the user is informed that there is no handwritten track recorded in the database similar to the present handwritten track.

While the invention has been described by way of example and in terms of a preferred embodiment, it is to be understood that the invention is not limited thereto. It will be apparent to those skilled in this field that various modifications may be made in these embodiments without departing from the spirit and scope of the present invention.

What is claimed is:

1. An input apparatus, comprising:
an input interface, for inputting a handwritten track having a stroke;
a processing unit, for analyzing a turning trend of said handwritten track; and
an execution unit, for executing a predetermined corresponding function based on the analysis result of said turning trend.

2. The input apparatus of claim 1, wherein said input interface is a touch screen.

3. The input apparatus of claim 1, wherein said input interface is a touch panel.

4. The input apparatus of claim 1, wherein said input interface at predetermined timing intervals records a coordinate point on said handwritten track for generating a series of coordinate points.

5. The input apparatus of claim 4, wherein said processing unit calculates angle or vector slope and length between two adjacent coordinate points of all the coordinate points on said handwritten track.

6. The input apparatus of claim 5, wherein said processing unit calculates the number and angle or vector slope of said coordinate points of said turning trend based on the variety of angle or vector slope between said adjacent coordinate points.

7. The input apparatus of claim 6, wherein said processing unit compares the number and angle or vector slope of said coordinate point of said turning trend with the predetermined turning trend previously stored in a predetermined database in order to verify said predetermined corresponding function to be activated.

8. The input apparatus of claim 1, wherein said predetermined corresponding function is preferably an automatic transmission back for predetermined messages, an engineering calculator, a volume adjusting or a quick shortcut equivalent to hardware buttons.

9. The input apparatus of claim 8, wherein said handwritten track is a heart-shaped stroke to perform returning a predetermined message.

10. The input apparatus of claim 8, wherein said handwritten track is α-shaped stroke to activate said engineering calculator.

11. The input apparatus of claim 8, wherein said handwritten track is a clockwise circling stroke or a counter-clockwise circling stroke for adjusting said volume.

12. The input apparatus of claim 8, wherein said handwritten track is a predetermined handwritten path with a stroke for equaling said fast shortcut of the button of the hardware.

13. The input apparatus of claim 12, wherein a function of equaling said fast shortcut of the button of the hardware is an execution program, a cut function, a paste function, a specific sentence or a macro function.

14. An input method, comprising the steps of:
inputting a handwritten track with a stroke;
analyzing a turning trend of said handwritten track; and
executing a predetermined corresponding function based on the analysis result of said turning trend.

15. The input method of claim 14, wherein a touch screen is provided for inputting said handwritten track.

16. The input method of claim 14, wherein a touch panel is provided for inputting said handwritten track.

17. The input method of claim 14, wherein the method further comprising the step of:
recording a coordinate point on said turning trend at predetermined timing intervals to generate a series of coordinate points.

18. The input method of claim 17, wherein the method further comprising the step of:
calculating angle or vector slope and length between said adjacent coordinate points based on said coordinate points.

19. The input method of claim 18, wherein the step further comprising the step of:
calculating the number and angle or vector slope of said coordinate points of said turning trend based on the variety of angle or vector slope between said adjacent coordinate points.

20. The input method of claim 14, wherein the step further comprising the step of:
comparing the number and angle or vector slope of said coordinate point of said turning trend with the predetermined turning trend previously stored in a predetermined database in order to verify said predetermined corresponding function to be activate.

21. The input method of claim 14, wherein the predetermined corresponding function is to provide returning a predetermined message, activating an engineering calculator, adjusting the volume or equaling a fast shortcut of the button of the hardware.

22. The input method of claim 21, wherein said handwritten track is a heart-shaped stroke to perform returning said predetermined message.

23. The input method of claim 21, wherein said handwritten track is α-shaped stroke to activate said engineering calculator.

24. The input method of claim 21, wherein said handwritten track is a clockwise circling stroke or a counter-clockwise circling stroke for adjusting said volume.

25. The input method of claim 21, wherein said handwritten track is a predetermined handwritten path with a stroke for equaling said fast shortcut of the button of the hardware.

26. The input method of claim 25, wherein a function of equaling said fast shortcut of the button of the hardware is an execution program, a cut function, a paste function, a specific sentence or a macro function.
